(19) United States
(12) Patent Application Publication
(10) Pub. No.: US 2014/0147822 A1
(43) Pub. Date: May 29, 2014

(54) COMPUTERIZED TEACHING AND LEARNING DIAGNOSIS TOOL

(71) Applicant: Dan Dan YANG, Ottawa (CA)

(72) Inventor: Dan Dan YANG, Ottawa (CA)

(21) Appl. No.: 13/684,424

(22) Filed: Nov. 23, 2012

(51) Int. Cl. G09B 7/02

(52) U.S. Cl. CPC G09B 7/02
USPC 434/350

(57) ABSTRACT

Systems, methods, and devices for providing digital content for educational and entertainment purposes. Learner computing devices for use by learners are networked with an educator computing device and a database server. Parameter input from the educator computing device is received at each of the learner computing devices and an activity is presented by the learner computing device to the learner. The activity's parameters are determined by the parameters received from the educator computing device. Data regarding the learner's performance in the activity is gathered and sent as a database entry to a database. A server then retrieves and processes the data and the processed data is sent to the educator computing device. The processed data displays whether the learner requires further instructions or more attention from the educator. Each learner computing device may be used with multiple learners.

### TECHNICAL FIELD

The present invention relates to educational systems. More specifically, the present invention relates to systems, methods, and devices which provide detailed real time assistance to educators and parents regarding how their learners are progressing with their education. These systems, methods, and devices also provide individualized assessments of each learner's progress level.

### BACKGROUND OF THE INVENTION

The increasing encroachment of digitization and computers into the daily life of the 21st century is well-known. Computers and digital data are increasingly replacing the analog world of pen, paper, and printed materials. This steady encroachment has not spared the educational world as computers, digital devices, tablets, and other computing devices are increasingly being used for educational purposes in classrooms and homes everywhere.

The rise of the tablet computing devices as well as the smartphone ushers in a new era of learner computing. In the classroom or at home, these devices provide quite a few advantages—they deliver a large amount of learning materials to the fingertips of learners, thereby making the learning fun and interactive and their size and weight make them very accessible to younger learners.

However, none of the presently available desktop computers, tablets, or learner computing devices do more than deliver learning materials. In other words, none of the existing computing devices provide opportunities where learners not only access learning materials in order to gain new knowledge, but which also collect and analyze learner's associated data to arrive at a learner's learning profile. Such a profile can be used by their educators to gain insight into the learner's actual learning process so that more personalized learning materials can be suggested for the learner.

From the above, it should be clear that no current systems or applications, for school or home, allow educators to quantify each learner's progress and capabilities. As an example, it is fairly common to hear people, whether it is the teacher, the parent, or the student himself note that 6-year Johnny is “not good at counting”. However, neither Johnny nor teacher nor the parents can tell the exact area in which Johnny is failing. Did Johnny get the wrong result because Johnny has issues with sequential order or did Johnny get the wrong result because he counts some numbers more than once?

Based on the above, there is therefore a need for systems and methods which allow for the use of computing devices, including desktops and/or portable computing devices, in classrooms and homes to assist in learning by delivering learning materials while, at the same time, gathering a learner's learning data so that this data can be analyzed. Once analyzed, they can be used to provide individualised and targeted learning materials specific to each issue during the learning process. Preferably, such a system would help educators understand each learner's learning status, weaknesses, strengths, and learning progress with appropriate learning materials being mapped to each learner's capabilities. More preferably, such a system would avoid a “one size fits all” approach where both advanced and delayed learners suffer while average learners do not have the opportunity to explore their hidden potential.

### SUMMARY OF INVENTION

The present invention provides systems, methods, and devices for providing a learning diagnosis structure which quantifies each learner's profile and assists educators in understanding in real time the effectiveness of the learning material for each learner, the areas in which the learner is lagging, and suggests learning material which have been mapped to a learner's specific profile.

Computing devices are networked and configured for learning material delivery, data gathering, analysis and reporting as well as delivering in real time suggested learning materials based on the analysis of the data gathered.

These computing devices include learner computing devices, educators computing devices, and data hosting/analysis computer servers. For home use, typically these computer devices can be combined into one desktop or laptop computer. For school use, these computers may include a student's computer or tablet computer, a teacher's computer or tablet computer, and a remote server.

The learner computing devices serve to receive learning materials, to gather each learner's performance data every time the learner uses learning material, and to upload the learner's performance data to a data server. The learning material has predetermined cumulative target milestones and the learner's progress in achieving these milestones while using the learning material can be data mined. Each learner's progress can thus be mapped to the milestone achievement database.

Learner data, for each individual learner and/or a group of learners, is provided in a report format and is accessed using the educator computing devices. This learner data is then used as the basis for selecting and providing learning materials that are standard or individualized based on the learner's progress. Based on the progress of the different learners in a group or on the percentage of learners achieving specific milestones or on an analysis of how the learner group is achieving target milestones, an educator can also fine tune or adjust the specific teaching method or learning materials for the group.

A computer server, if present, performs the function of collecting performance data gathered from each learner computing device. In addition to this, the server performs the data analysis on the learner performance data including mapping the learner performance data to the targeted milestones and providing reports to educators.

For some situations where computing power and storage are at a premium, such as in a home use situation, the data collection, analysis, and speed of the analysis may need to be discounted. Also, in such situations, instead of using multiple computing devices, a single computing device may perform the various functions assigned to the different computing devices noted above.

In a first aspect, the present invention provides a system for providing educational digital content to learners, the system comprises at least one learner computing device, each of said at least one learner computing device being for use by at least one learner.

The system may further comprise an educator computing device for use by an educator, said educator computing device communicating with said at least one learner computing device. This educator device can be combined with the learner device if necessary. The system can further comprise a server communicating with said at least one learner computing device and said educator computing device, with the server being for collecting and processing data received from said at least one learner computing device. The server is optional and may be combined with the learner or educator device. The server system can include a reference database containing a complete list of achievement milestones and sub-milestones with age and level references. The collected data from learners are compared with these milestones. The system also includes a learner specific database containing data collected from each learner, the data collection occurring whenever each learner uses specific learning material that contains pre-determined achievement milestone targets. This learner specific database has specific learner profiles which contain learner achievement records based on the target milestones. For this system, the at least one learner computing device delivers the learning activity to at least one learner, the at least one learner computing device gathers data regarding the performance of the at least one learner in the activity and sends the data as a database entry to the learner database.

Each database entry stored by the learner database and originating from the at least one learner computing device details: an activity through a specific learning material, an identity of the learner which may include learner's name, age, and location information such as school and classroom, and a result or results of the activity for the learner.

The server processes the database entries regarding the performance and generates at least one report on the learning activity, with comparison to the reference database containing target milestones. The least one report is viewable by the educator on the educator computing device.

In a second aspect, the present invention provides a method for providing individualised learning material to a learner, the method comprises: receiving learning material from a computing device, providing said learning material to a learner computing device by providing activity-related indicia with built-in data collecting mechanism to said learner, receiving input from said learner, said input being related to said activity, determining said learner's achievement for said activity, generating achievement data based on said activity, and transmitting achievement data as a database entry to a learner database.

For this aspect of the invention, each activity relates to at least one milestone and data collected by the said learner database includes data on said learner and which milestones have been achieved by said learner. As well, each database entry collected by said learner database and originating from said at least one learner computing device details an activity, an identity of said learner, and at least one result of said activity for said learner. The database entry stored in a database may include the results of an analysis of the learner's performance in the activity when compared to the reference database which contains the target achievement milestones. The database entry may also include the learner's achievements relative to the entries in the reference database. Thus, if a learner fails at an activity or performs better than expected at an activity, the learner's performance is compared with other milestones that may be surpassed or achieved by the user's performance. A learner can therefore “jump” ahead by achieving milestones that may otherwise not be attainable by a better than expected result. Similarly, if a learner fails at an activity, the learner may not achieve the milestone at which the activity is aimed at but a lower level milestone or a different milestone may be achieved.

In a third aspect, the present invention provides a method for determining a learner's progress profile in comparison to target milestones stored in a reference database, the method comprising the steps of: providing learning material to said learner by way of an activity presented to said learner through a learner computing device, determining said learner's achievement in said activity, sending said learner's achievement data for said activity as a data entry to a learner database, determining if said learner has met specific milestones based on said learner's achievement data collected during said activities, in the event said learner has not met said target milestone or has achieved better than target milestone, determining which upper or lower level milestones have been achieved, generating a report based on results from the determinations made and making the report accessible via an educator computing device.

For this aspect of the invention, each database entry stored by the database and originating from said at least one learner computing device details an activity, an identity of said learner, and at least one result of said activity for said learner. The database entry to be stored on a learner database may include the results of an analysis of the learner's performance in one activity when compared to the target achievement milestones entries in a reference database. The database entry to be stored in the database may also include the learner's achievements in comparison to the reference database for upper and lower level milestones in case the learner fails in an activity or performs better than expected in the activity.

In a fourth aspect, the present invention provides computer readable media having encoded thereon computer readable and computer executable instructions which, when executed, implements a method for providing learning material to a learner, the method comprising:

a) receiving learning material from a computing device;
b) providing said activity to a learner computing device by providing activity-related indicia to said learner;
c) receiving input from said learner, said input being related to said activity;
d) determining said learner's achievement for said activity;
e) generating achievement data based on said activity;
f) sending achievement data as a database entry to a learner database;
wherein
each activity relates to at least one milestone;
data collected in said learner database includes data on said learner and which milestones have been achieved by said learner;
each database entry stored by said learner database details
   an activity,
   an identity of said learner,
   at least one result of said activity for said learner,
   results of an analysis of at least one performance by said learner in said activity where said performance is compared to entries in the reference database which contains target achievement milestones, and
   achievements of said learner relative to entries in the reference database for lower and upper level milestones for when said learner fails in said activity or when said learner performs better than expected in said activity.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a flowchart detailing the steps in a method according to another aspect of the invention; and

FIG. 3 is a flowchart detailing the steps in another method according to yet another aspect of the invention.

### DETAILED DESCRIPTION OF THE INVENTION

Within this document, it should be understood that the term “learner” encompasses a person who is in the process of learning, whether in a formalized learning environment or not. This includes students, regardless of age, and children who might be learning on their own or who may be coached or assisted by an older instructor. The term “educator”, in this document, includes any person or group of persons who are educating, instructing or who are assisting in the education, instruction, of a learner. Thus, a learner may be a child at home learning on their own (or guided by an older relative or a tutor) or a student in a classroom being taught by a teacher in a traditionally structured environment. Similarly, an educator may be a parent assisting their child, a teacher in a classroom setting, a tutor with one or more pupils, or any other person who may be involved in teaching, instructing, or otherwise educating a person.

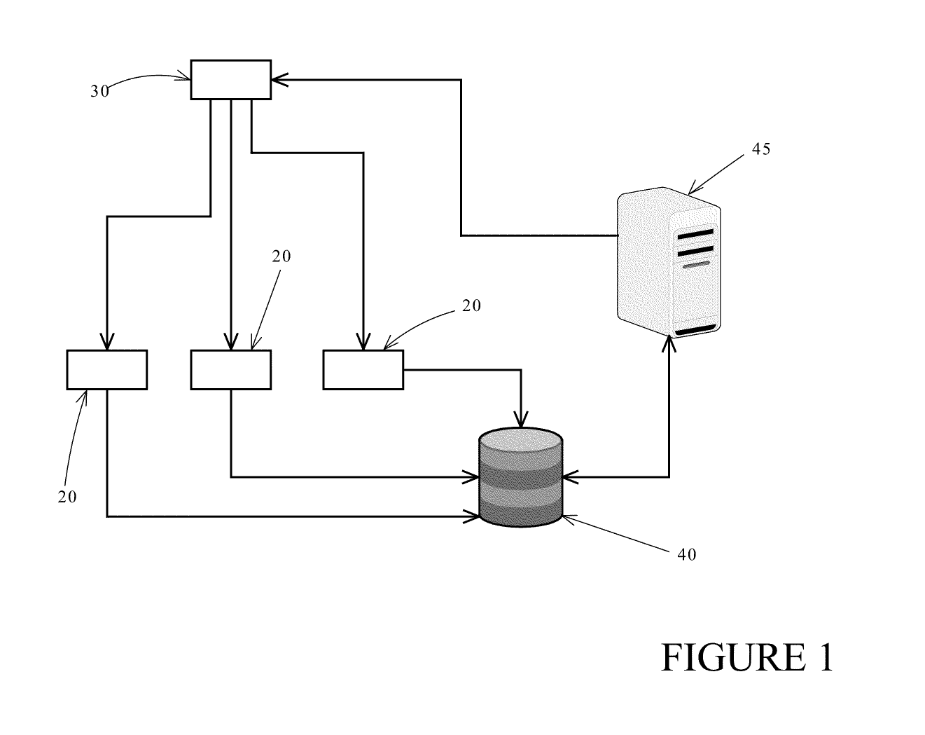

Referring to FIG. 1, a block diagram of a system according to one aspect of the invention is illustrated. The system 10 has a number of learner computing devices 20, an educator computing device 30, and a database 40 which may be resident on a server 45. The educator computing device 30 sends parameters for an activity to the learner computing devices 20. Learners 50 are presented with the activity by the learner computing device they are using and their progress in the activity is logged on their learner computing device. Each learner's performance is then logged on their learner computing device and the data is sent to the database 40. The server 45 then processes the performance data for each learner and the processed data is sent to the educator computing device 30. The educator using the educator computing device 30 is then presented with the processed data and can then determine which learner requires more instruction or more attention. Similarly, the educator can also see if his or her teaching methods have been effective or not by looking at the various performance results as a whole.

Each learner computing device may take the form of a tablet computing device, a smartphone, a computer notebook, a netbook, or any other device which may be used for data processing. Preferably, the learner computing device is portable. The learner computing device should, preferably, be able to communicate wirelessly with the database and/or the server, the educator computing device, or any other wireless computing device or network.

In one configuration, each learner computing device is used by a single learner. Each learner is provided with a profile on the database server so that each learner's performance for activities can be stored, tracked, analyzed, and reported to the educator computing device.

In another configuration, each learner computing device is used by multiple learners. Each learner, prior to using the learner computing device, logs on to the device and accesses his or her personal profile on the learner computing device. Once logged in, each learner can access the activity currently activated and his or her progress and/or performance is then logged on to his or her profile on the device. Once logged into the device, the performance data is then uploaded (as a database entry) to the database and the server can retrieve this data for processing as described above. Of course, each learner's performance data is logged on to his or her own profile on the database.

For ease of use by learners, it is preferred that the learner computing device be equipped with not just a graphical user interface but with a touch screen based GUI.

The educator computing device may take the form of another learner computing device (e.g. a tablet computing device), a desktop computer, a notebook computer, a suitably configured server, or a netbook. The educator computing device receives processed data from the server which indicates how each learner is progressing or performing in that activity. As well, the processed data can detail each learner's progress through various milestones with each milestone being a skill/ability/capability in which the learner has demonstrated at least some facility or knowledge.

The server can be any suitable desktop, laptop, or other type or form of computing device which can communicate wirelessly with the various learner computing devices and the educator computing device.

The database can be resident on the server or it can be resident on another server at another location. As noted above, the database receives performance data from the learner computing devices and this data can be retrieved by the server which processes this data, and then transmits the resulting processed data to the educator computing device.

The various components of the system illustrated in FIG. 1 can communicate with one another wirelessly. The different components (i.e. the various learner computing devices, the educator computing device, the database, and the server) can be wirelessly networked to each other using a wireless network which uses well-known wireless network protocols. Communications between the various components can be effected by using specific modules tasked with dealing with a specific component. As an example, the educator computing device may be equipped with a module for dealing with the packaging and transmission of parameters for activities to the various learner computing devices. The same educator computing device can also be equipped with a module for receiving processed data from the server and for presenting that data to the educator. Each learner computing device can be equipped with a module for sending performance results or performance data to the database and another module for receiving parameters directly from the educator computing device.

For ease of implementation, the various learner computing devices, educator computing devices, server, and database can all be connected or communicating with one another using the Internet. The educator computing device can use web browser-based software to review/receive reports or processed data from the server. Similarly, the database may be logically located on a remotely located server and be accessible to the various devices and servers through the Internet. The database may also comprise multiple databases containing different data sets and data types as will be explained below. Instead of a unitary database, the database may be separated into discrete portions, each containing different datasets for use in different aspects of the present invention and for use in different manners by these different aspects of the present invention.

It should be noted that the activity that each learner engages in using the learner computing device can be any suitable digital device based activity. Activities that are based around simpler tasks such as counting, identifying specific animals or icons, and the like are suitable for this invention. Of course, more complex tasks such as spelling, difference recognition, arithmetic-based activities, and other activities with an educational component may also be used. Preferably, the activities selected for the present invention involve the learner selecting his or her answers from a range of possible answers with the learner indicating his or her choice by touching the selected answer or answers. The learner can be presented with the activity and then be given a range of potential answers. The learner can then touch selected answer or answers from the options given on the touch screen interface. If the selected answer or answers are incorrect, then the activity can iterate a number of times to provide the learner with multiple opportunities to select the correct answers. To assist the learner, each iteration (after the first) may have fewer potential answers than the immediately preceding iteration. This provides the learner with fewer options and, thus, a greater chance at selecting the correct answer or answers. Part of the parameters sent by the educator computing device to the learner computing devices may be the number of iterations allowed, the type of changes in the activity for each iteration (e.g. are the number of options to be decreased/is the number to be counted to be changed), how many options are to be given for each iteration, and the amount of time allowed for the learner to complete the activity per iteration (e.g. for the first iteration, the learner may be given 45 seconds, for the second iteration, the learner may be given 40 seconds, for the third iteration the learner may be given 30 seconds, etc., etc.).

From the above, a number of examples can be given to assist in further description. One example relates to a counting-based activity. The learner is provided with a picture of a beetle or lady bug with spots on the wing. The learner is then prompted to count how many spots or dots are on the lady bug's wings. Based on the configuration, the learner either enters how many dots are counted on the wings by selecting from a number of options or the learner can individually touch each and every dot on the wing and only after this can the user enter the number of dots counted. In the event the learner does not perform a proper count of the dots on the lady bug's wings, subsequent iterations can reduce the number of dots on the lady bug. Conversely, instead of changing the number of dots, the number of dots may stay the same but the numbers provided as options may be changed between iterations. In terms of the learner's performance, this can be based on how many iterations were needed to select the correct number of dots. Similarly, further performance can be measured by determining whether the learner only activated or touched each dot once.

Another example of an activity which may be used with the system in FIG. 1 relates to spelling. The educator may verbally provide a word to be spelled to the learners with the learner computing devices. The learner computing devices may then provide the learners with a listing of an alphabet and a number of blank spaces corresponding to the letters of the word the educator asked the learners to spell. The learners can then drag specific letters to the blank spaces. Alternatively, to make the activity easier, instead of presenting the learners with a full alphabet, a subset of the alphabet can be presented, thereby limiting the learner's options. Or, in another alternative, all the letters which spell out the word can be presented to the learner in a jumbled fashion. The learner merely has to drag each letter to its proper position in the word blanks to properly complete the activity. A further alternative may show the learner some of the letters which form the word. The learner merely has to fill in the blanks for the rest of the letters for the word. As part of the parameters sent from the educator computing device for this activity, the parameters may include the amount of time allowed to the learner per iteration, the number of extra letters shown to the learner, and whether some letters of the word are to be revealed to the learner.

Another further example of an activity which may be used for this invention involves the learner matching young animals with their parents. For this activity, the learner is presented with a number of young animals on one row and a number of adult animals on another row. The learner has to pair each young animal with its corresponding adult version (i.e. pair up a child animal with its parent). Performance and progress for the activity can be measured by the learner's success rate as well as the number of iterations or attempts before all the young animals are properly paired with their parent.

Once the learner has completed the activity or once the time allotted for the activity has passed, the learner's performance-related data is gathered at each of the learner computing devices and is then transmitted to the database. As noted above, the performance data may take different forms and may measure different metrics. These forms and metrics may, of course, be dependent on the activity. The data package sent from each learner computing device to the database includes an identification of the learner, the performance data, an identification of the activity for which the performance data relates, an identification of the result of the activity, and reasons for the result. The data package may be sent to the database using well-known wireless protocols and well-known data transfer techniques.

At the database, the database receives these database entries using suitable hardware and the data package containing the performance data is received from each learner computing device. The data in the data package is then extracted and stored in the database and is linked to the profile for the learner to which the data pertains is retrieved. Using the server, the relevant data for a user or a group of users is retrieved from the database and the performance data is analyzed. The analysis may be as simple as comparing the performance data with predetermined thresholds to determine if the performance meets or exceeds the thresholds. Alternatively, the analysis may involve aggregating the performance data from the rest of the group (i.e. the rest of the learners) and determining whether a specific learner is outperforms, performs as well as, or underperforms relative to the rest of the group. More intense analysis of a learner's performance, including his or her performance in a variety of activities and with data gathered over a period of time, can also be performed. Such a deeper analysis, when compared with data from the rest of the group of learners, can be used to determine how a specific learner is performing relative to the group. However, for a single activity, a learner's performance can be aggregated with the performance of the rest of the group against a predetermined metric to determine whether the lesson or activity has been learned or understood by the group. For this single activity use, the aggregated performance data for the group can be sent to the educator computing device along with the individual performance results for the individual learners.

Once the server has analyzed the performance data from the various learner computing devices, the aggregated and analyzed data is then sent to the educator computing device. The educator computing device receives the analyzed data and displays it for the educator. The manner in which the data is displayed may depend on the configuration of the educator computing device as well as the activity to which the data relates. As an example, if the activity relates to counting items on the screen, the performance data could be presented as scores or bar graphs denoting how many errors each learner made, how many iterations were needed before each learner to garner a perfect performance, and how long it took each learner to count the items. Similarly, if the activity was spelling based, the number of errors made by the various learners can be displayed numerically. For the spelling activity, the number of learners who spelled the word correctly can be portrayed as a portion of a pie graph. The use of line, bar, or pie graphs can quickly and easily provide the educator with a visual indication of his or her success in teaching the learners. If most of the learners are completing the activity correctly, then the educator's methods are effective. If most or at least half of the learners are not completing the activity, the educator's methods may not be as effective or the educator may wish to switch teaching methods. Alternatively, low activity completion rates or low correct activity performance may mean that the educator needs to reiterate, re-teach, or revisit the previous lesson.

It should be noted that, in some configurations of the educator computing device, the educator can reconfigure how the performance data is displayed. As an example, the educator may be presented with a table detailing the performance of each learner in an activity, with the performance being denoted by how many errors were committed by each learner. The educator can then reconfigure the data presentation to show how each learner performed relative to the group. A graph can show whether each learner's performance exceeded, performed as well as, or underperformed relative to the aggregate or the average of the group.

For the educator computing device, an activity can be initiated by first ensuring that all the learner computing devices to be used by the learners are properly logged into the network and that the relevant learners are properly logged into their respective profiles. This can be done by having the educator computing device query each learner computing device to determine which profile is being used on which learner computing device. The educator can then, by visual inspection, confirm that the correct learners are using the learner computing devices. Of course, this confirmation is only needed if multiple learners are using each learner computing device. Once this confirmation is complete, the educator can then instruct the various learners to launch a specific application that will lead to a specific activity. (Note that the application relating to the activity may originate from the educator computing device—the educator computing device may upload the application to the various learner computing devices.) Once the application is launched, the educator can launch an application on his educator computing device. This application can then be used to send activity parameters to each of the learner computing devices. Depending on the configuration of the educator computing device and the various learner computing devices, the learners may not be presented with the relevant activity until their learner computing device has received the parameters from the educator computing device.

For ease of use, the educator may be presented with a menu of parameters to set for each activity. Thus, if the activity is counting related, the educator may be presented with a menu where he can simply select a number of dots to show each learner, a maximum number of iterations for the activity, and perhaps whether the number of dots is reduced for each iteration. Similarly, for spelling related activities, the educator can set the word to be spelled, how many extra letters are to be provided as options, and whether some of the letters of the target word are to be revealed to the learner. Arithmetic related activities can give the educator the option to set the arithmetic problem to the solved (e.g. whether the problem is addition, multiplication, division, or subtraction), the numbers involved, which portion of the equation is to be blanked out, and how many options (for numbers) are to be presented to the learner.

It should be noted that each educator computing device may, depending on the configuration, control the activity on each learner's learner computing device. The educator computing device may be given application control including, among others, initiating the application, shutting down the application, and pausing the application. However, for a simple implementation, the educator computing device can merely send operating parameters to the application which may already be resident on the learner computing device. Control by the educator computing device over each learner computing device and its applications may be minimal (for a simple implementation) or it may be complete (for a more complex implementation).

Similarly to the above, the educator computing device may be configured to monitor the activities on each of the learner computing devices. The educator computing device may be configured to receive up to date data on each learner computing device's activities such as which applications are active, whether data is being entered, etc., etc. This capability can be used to determine whether or not learners are actually participating in the activity.

The database noted above and which is used in the invention has a unique structure that allows other applications to take advantage of the benefits of the system.

The database has a structure wherein each item is provided with its own table and the columns within that table describe the item. As an example, for an implementation where schools are using the system, each school will be provided with its own table in the database and the columns for each school's table will describe the school's specific characteristics such as the school's name, address, etc., etc. To refer to a specific school in a table, a schoolID, a unique identifier identifying a specific school, is used. Similarly, each learner, who may be learners in a school, is provided with a specific table. The columns in each learner's table denote that learner's name, school, subjects, educators, etc., etc.

To ensure suitable flexibility in how the system may be used and in which applications and activities may use the system, each activity will produce specific database entries for each learner who uses that activity or application. In one implementation, each learner's performance is tracked by the database entry produced every time the learner uses that activity/game/application. Thus, every time the learner uses that game/application, a database entry is generated on the computing device. This database entry is then uploaded for storage on the database. As can be imagined, the upload can be sent to the server, to the cloud, or to any suitable intermediary computer/server/service for eventual storage in the database. A sample format for such a performance data database entry is provided below:

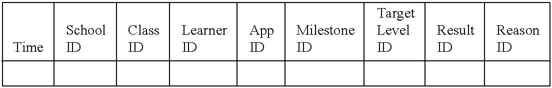

To explain the various columns in the above database entry, the following table is provided:

| | |
|---|---|
| Time | Time that the data was taken |
| School ID | ID of the school which points to a row in |
| | the School table which describes the school |
| | of the learner |
| Class ID | ID of the class which points to a row in the |
| | Class table which describes the class of the |
| | learner |
| Learner ID | ID of the learner which points to a row in |
| | the User table which describes the learner |
| App ID | ID of the application which points to a row |
| | in the Application table which describes the |
| | Application which the learner is running |
| Milestone ID | ID of the milestone which points to a row in |
| | the Milestone table which describes the |
| | milestone which is being measured |
| Target Level | ID of the target level which points to a row |
| ID | in the Target Level table which describes |
| | the targeted level of the milestone which is |
| | being measured |
| Result ID | ID of the result which points to a row in |
| | the Result table which describes the result |
| | of the measurement |
| Reason ID | ID of the reason which points to a row in |
| | the Reason table which describes the reason |
| | for the measured result |

As can be seen from the above, each item, whether it is a school, a learner, a class, an application, a milestone, a result, or even a reason for the result, is given its own table. Of course, the learnerID is a unique identifier which specifically identifies one specific learner.

To further explain the above table and how the various columns and tables provide flexibility for applications and for sorting results, the various items in the columns are described below.

The performance data embodied in the various tables and columns noted above are based on the following performance parameters: Milestones, Target Level, Result, and Reason. The other parameters are provided in the performance data database entry to specify which learner the data is for and to allow for easy sorting of the data.

For the Milestone performance parameter, its corresponding Milestone table will have a number of entries which describe the different milestones which are being tested by a game or application. As an example, if a counting game such as the beetle or lady bug game described above was the activity, one parameter which could be tested would be the learner's ability to perform a visual assessment (i.e. visually determine the number of dots on the ladybug's wings). For this example, “Visual Assessment” would be an entry in the milestone table. As noted above, a Milestone can be defined as a skill, ability, or capability which is desired to be cultivated, taught, or nurtured in the learner. Once the learner has shown some facility in this skill, ability, or capability, the milestone can be listed as being achieved. Milestones can be cumulative such that higher level target milestones are only achieved or are only achievable once specific lower level milestones have been achieved. As an example, 3 or 4 specific lower level milestones may be required to have been achieved before a learner is provided with an activity for a higher level milestone. It should be noted that the lower level milestones do not necessarily have to relate to the higher level milestone.

For the Target Level parameter, its corresponding Target Level table will have a number of entries, each of which describes a different level of the milestone being tested. To allow for this parameter to applicable to different milestones, the level can be kept generic or general. Continuing the ladybug example game above, when testing the learner's ability to perform a visual assessment, the application can start by showing a random number of dots. In this example, the Visual Assessment milestone would have various Target Levels, each of which is derived from the number of dots presented to the learner. As such, the various entries in the Target Level table could be 2, 3, 4, and 5 as these would be the number of dots presented to the learner. In other words, the entries in the Target Level table are what the learner should be attempting to achieve to reach the milestone being tested. For the ladybug game, the target levels are the number of dots on the ladybug's wing that the learner has to visually assess.

For the Result parameter, the Result table has rows which describe the result which are measured during the testing for the milestone. This parameter is preferably kept generic so that different types of tests and measurements can use the parameter. As an example of how this parameter operates, we can again use the example ladybug game described above. For the ladybug game, when the visual assessment milestone is measured, there are only two possible results: a correct or an incorrect visual assessment. It should be noted that, for other milestones, the Result parameter may include other possible results.

For the Reason parameter, the corresponding Reason table contains rows which describe the possible reasons for the result which was measured. For the ladybug game example, the visual assessment milestone may have reasons would include: “child has counted more items than shown”, “child has counted fewer items than shown” and “child has counted number of items shown”. The entries in the Reason table are therefore the justifications for the results of the performance measurements.

It should be noted that the entries in each of the tables for the above parameters can be re-used by multiple games or applications. It is preferable that the entries in these tables are reused when measuring the same feature to assure that analyses using the data in the database are performed correctly. As an example, two applications may both measure “Visual Assessment”. Both applications will have to store the data under the same milestone ID of “Visual Assessment” and use appropriate Target Level, Result and Reason ID entries. If the use of these parameters is consistent, a query for data for a child's performance on “Visual Assessment” will provide consistent results.

As noted above, each learner computing device gathers performance data for each instance a learner uses an application or activity. Below is provided a simplified version of a database entry that a learner computing device compiles and sends to the database for storage after a learner uses an application.

| | |
|---|---|
| Time | 11:23:44 am |
| School ID | School 1 |
| Class ID | Class 1 |
| Learner ID | Learner 1 |
| App ID | App 1 |
| Milestone ID | Visual Assessment |
| Target Level ID | Count to 3 |
| Result ID | Incorrect |
| Reason ID | child has counted fewer items than |
| | shown |

The performance data database entry was for the ladybug example game previously described. For this example instance, the learner was shown 3 dots and the learner selects a count of 2. For the next iteration of the activity, the learner is shown 2 dots and the learner correctly counts 2 dots and correctly enters 2 dots. The resulting database entry generated then becomes:

| | |
|---|---|
| Time | 11:25:44 am |
| School ID | School 1 |
| Class ID | Class 1 |
| Learner ID | Learner 1 |
| App ID | App 1 |
| Milestone ID | Visual Assessment |
| Target Level ID | Count to 2 |
| Result ID | Correct |
| Reason ID | child has counted number of items |
| | shown |

As can be seen from the above, a multitude of options are available to the educator when it comes to data mining the results from the activities of the learners. For example, if the educator needed to determine how many learners can correctly perform visual estimation and continue counting up to 10, a search for parameters in the database where database entries denote a Target Level of “Count to 10”, a Result of “Correct” and a Reason of “Child is correctly visual estimating and continue counting” can be performed. The results would show which learners were able to perform per the searched for criteria. However, if the search showed that none of learners were able to complete this milestone, a search can be performed for entries with a Result of “Correct” and a Reason of “Child is correctly visual estimating and continue counting”. The results of the search can then be collated and the educator can then display the Target Level for each of these found entries to see how high the learners can correctly visually assess and continue count. For example, the results could be shown as a bar graph and it could show that 25 of the learners can meet the milestone when shown 5 dots, 20 with 6 dots, 19 with 7 dots, but only 3 with 8 dots, and 0 with 9 or 10 dots.

The above highlights how the use of these performance parameters simplifies data analysis. As an example, if we need to know how many of the learners children can correctly perform visual assessment of 5 dots, one simply needs to search the database for all entries with a Target Level ID of “Count to 5” and a Result ID of “Correct”. Of course the search may need to be narrowed to only the learners in a specific classroom and a specific school so that other classes and schools are excluded.

As another example, if the educator needed to know how many learners are estimating more dots than the number shown, the educator would merely need to properly formulate the query. The educator could then search the database (again constrained to the specific classroom and school) for all the entries with a Reason ID of “child has counted more items than shown”.

The use of the above parameters (Milestone, Target Level, Result and Reason) allows for the handling of different scenarios while simplifying the search and data comparison tasks.

The database system also allows for finer granularity in the data such that more detailed searches and data analysis can be performed. One example of such a capability requires more entries in the milestone table. An added milestone can be titled “Visual Assessment plus Continued Counting” with its own set of data for the Milestone, Test Level, Result and Reason tables. For this set of data, some of the values may overlap with the set of data for the Visual Assessment milestone.

In the above example for Visual Assessment plus Continued Counting, the Target Level can be very specific (e.g. “visual assessment of 4 dots plus continued counting of 3 dots”) or it can be less specific (e.g. “count to 7”). The detail level for the Target Level may depend on the specificity desired for the search and analyze function. As an example, if we only wish to determine how many learners can or cannot count to 7 and we do not wish to differentiate between learners who cannot add 3+4 or 5+7, the target level can be set to “count to 7”. However, if it is important to determine which learners were able to calculate/count 3+4 and which learners were able to calculate/count 5+2, then a higher level of detail is needed in the Target Level entries. This flexibility allows activity and application developers to determine the level of granularity that can be achieved when performing data analysis and data searching.

Continuing the above example for Visual Assessment plus Continued Counting, the entries in the Result table can be set to “correct” or “incorrect”. The reasoning for the result achieved can be placed at the Reason table.

For the Reason table for this new milestone, two approaches can be taken: very detailed Reasons can be given or more generic Reasons can be used while categorizing the results. The detailed reasons can describe what the learner did and how these actions were correct or incorrect. As examples, these detailed reasons can include: “items on right are touched once and result is correct”, “items on both left and right are touched once and result is correct”, “items on left and right are touched once and result is incorrect”, “items on right are touched once and result is only right items”, “items on right are touched more than once and result is more than the items on the right”, and “items on right are touched once and result is more or less than total number of items”.

Conversely, the less detailed but categorized reasons can include: “child is not visually estimating”, “child is using wrong reference”, “child is skipping numbers”, and “child has counted number of items shown”. Of course, the determination as to when to use which result and which reason is based on the internal logic of the application or activity.

For this new milestone, an application or activity can generate the following database entry for storage in the database:

| | |
|---|---|
| Time | 11:25:44 am |
| School ID | School 1 |
| Class ID | Class 1 |
| Learner ID | Learner 1 |
| App ID | App 1 |
| Milestone ID | Visual Assessment and Continued |
| | Counting |
| Target Level ID | Count to 7 |
| Result ID | Correct |
| Reason ID | child has counted number of items |
| | shown |

The above database entry was created after the learner was presented with 3 dots on a left wing of a ladybug and 4 dots on a right wing of a ladybug in an activity where the learner has to determine how many dots are present on the ladybug and to touch or activate some of the dots on the ladybug. For this database entry, the learner touched each of the 4 dots on the right wing and was supposed to visually estimate how many dots were on the left wing. The learner then selected a total number of 7 dots.

For the next iteration of the example, the learner is presented with 5 dots on one wing and 5 dots on the other wing. After the learner touches all the dots on one of the wings once and selects a count of 8, the following database entry is produced:

| | |
|---|---|
| Time | 11:26:44 am |
| School ID | School 1 |
| Class ID | Class 1 |
| Learner ID | Learner 1 |
| App ID | App 1 |
| Milestone ID | Visual Assessment and Continued |
| | Counting |
| Target Level | Count to 10 |
| ID | |
| Result ID | Incorrect |
| Reason ID | child is skipping numbers |

As can be seen, the learner correctly counted the dots by touching them. However, the learner's incorrect result shows that the learner is not keeping proper track of the numbers.

In another example, the learner is shown a ladybug with 2 dots on the left wing and 4 dots on the right wing. The learner then touches all the dots on both wings and enters a value of 6. This instance of the use of the application results in the following database entry:

| | |
|---|---|
| Time | 11:26:44 am |
| School ID | School 1 |
| Class ID | Class 1 |
| Learner ID | Learner 1 |
| App ID | App 1 |
| Milestone ID | Visual Assessment and Continued |
| | Counting |
| Target Level ID | Count to 6 |
| Result ID | Incorrect |
| Reason ID | child is not visually estimating |

As can be seen from the database entry, the learner is not visually estimating the number of dots as the learner is touching and counting all the dots.

As noted above, the milestones used in the database can be cumulative such that achievement of lower level milestones can lead to the achievement of higher level milestones. As an example, from the above example of counting dots on a lady bug, if the learner was originally presented with 3 dots on the ladybug and then is presented with three more dots, if the learner only touches the further 3 dots, a table for the milestones and results may be as follows:

| Milestone | Target Level | Result | Reason |
|---|---|---|---|
| 3100-04 - | Count to 6 | Correct | Learner has |
| Point and | | | counted number of |
| count | | | items shown |
| 3100-05 - | Count to 6 | Correct | Learner has |
| Sequential | | | counted number of |
| quantity | | | items shown |
| 3120-01 - | Count to 6 | Correct | Learner has |
| Count | | | counted number of |
| starting at | | | items shown |
| 2, 3, 4, or 5 | | | |
| 4100-01 - | Count to 6 | Correct | Learner has |
| Continued | | | counted number of |
| count and | | | items shown |
| visual count | | | |

As can be seen from the above, the higher level milestone (continued count and visual count) builds on the lower level milestones. Specifically, the milestone denoted by the code 4100-01 requires the milestone denoted by 3120-01 to work. For clarity, it should be clear that “continued count” cannot operate without the lower level milestone of “count starting at 2, 3, 4, or 5”. Of course, while the above shows that some target milestones may depend on lower level milestones, this is not necessarily the case for all milestones. Some target milestones may require lower level milestones which are not directly related to the target milestone.

To assist the educator in determining a learner's progress, the educator computing device may receive a report regarding the data processed from the database. In one implementation, the report provides details on each learner's progress towards a specific target milestone. In another implementation, the report provides details for the progress of a group of learners towards a specific group target. As an example, the report can detail how many learners achieved the target milestone and how many did not. As well, the report can detail which lower level milestones were achieved by the learners who did not achieve the target milestone. This type of report can show the educator where his or her methods have been effective and where they have not been effective. The report can even provide reasons, culled from the database data, as to why each learner failed to achieve their milestones. As will be explained below, the report may also contain recommended activities and learning materials for each learner. These recommended activities and learning materials can be based on each learner's determined shortcomings or unachieved milestones.

The use of these above specific parameters allows for a common assessment platform to be used among different activities, applications, and games. For ease of use of these parameters across different applications and activities, it is preferred that developers of these applications use the specific parameters as outlined above. Such use would allow for consistency in the application of the parameters and in the results of data mining in the database.

Regarding the implementation details for the above database, it should be clear that various tables will need to be defined and created in the database and in the various computing devices involved in the system. The design and the implementation of these various tables are within the purview and capability of a person skilled in the art.

In one implementation, the learner database includes a reference database containing a complete list of achievement milestones and sub-milestones with age and level references. Data collected each time a learner uses an application is compared against these milestones and sub-milestones. If necessary, this comparison can also take into account the specific learner's age. In addition to the reference database with the milestone related data, the system also includes a learner specific database containing historical data collected from each learner. Every time a learner uses specific learning material on the learner computing device, data is gathered on how the learner performed when using the learning material. This data can be used to determine how the learner is progressing towards pre-determined achievement milestone targets. The data gathered can be stored in a learner specific database that has at least one specific learner profile for each learner. Each learner profile contains learner achievement records based on the target milestones for that specific learner.

As noted above, each learner computing device delivers the learning activity to the learner with the learner computing device gathering data regarding the performance of the learner in the activity. The learner computing device then sends the data as a database entry to the learner database. The learner specific data is then stored in the learner specific database in a learner profile specific to the learner whose performance generated the data. The data received at the database for storage can be cross-referenced with specific milestones, both lower level and upper level milestones.

In addition to the various milestones associated with the various activities, the reference database can also include a database for recommended activities and other learning material which can be used to address learner issues. As an example, if a learner's performance data indicates that the learner is deficient in one area or does not seem to understand to achieve a particular milestone, the reference database contains activities or other learner material which can be used by or in conjunction with the learner to address the learner's issues. Thus, as an example, if a learner seems to be unable to count to 10, the reference database can contain activities or learning material that covers counting to 5, counting to 7, and counting to 8. For this example, the reference database contains activities or learning materials that can be used to check to see if the learner can count to a lower number. If the learner cannot count to the lower number then the learner will need to learn or master these activities before he or she can proceed to counting to 10. For a simpler implementation, the reference database may have entries which, when accessed, details lower level activities that can be used to build up to the higher level activities. Other entries, each of which may be associated with different milestones, can detail other activities or learning materials which can be used to address learner issues.

In use, when a learner's performance data relative to an activity is analyzed and the milestones achieved or not achieved by the learner are determined, the end result of the analysis can include a reference to the reference database. As noted above, the reference database includes entries associated with different milestones. The entries associated with the milestones that the learner failed to achieve for the activity can thus be accessed and the activities and learning materials in the entries can be presented as part of the report sent to the educator computing device. The report resulting from the analysis thus shows not simply how well or how badly the learner performed, the areas where the learner were assessed in, but also remedial activities or learning materials which can be used to address the areas in which the learner underperformed. The reports for each learner can also be stored in each learner profile stored in the learner specific database.

The reference database can also be used to determine a learner's performance relative to not just which milestones are associated with the activity just completed but with all available milestones. After a learner's performance data has been uploaded to the learner database, the performance can be assessed/analyzed against all or most of the milestone entries in the reference database. This step will ensure that, regardless of the learner's performance relative to the milestones for the activity, the learner will be awarded with milestones he or she has achieved even if the milestones do not directly related to the activity just completed. Thus, if a learner fails a specific activity, the learner can still be awarded milestones that he or she has achieved even if the milestones are not for that particularly activity. Similarly, if a learner has overachieved or has done really well in an activity, the learner may be awarded milestones that are beyond what he or she may be otherwise entitled to. As an example, doing very well in one activity may provide a learner with milestones that leapfrogs or avoids other activities.

While the above description contemplates an organized and formalized classroom setting with the educator role being filled by a teacher, teacher's aide, or other similar person, the different aspects of the present invention can also be implemented in a home setting. For such a home setting, the learner can be a child equipped with a learner computing device and the educator can be a parent, tutor, relative, or similar person whose education-related function is not as formalized as a teacher or teacher's aide. For the home setting implementation, a smaller database may be used. A smaller reference database, with perhaps a smaller set of milestones and recommended activities, may be used. A learner specific database would, of course, be much smaller as multiple learners may not need to be included as entries in the learner database. The database itself may not be resident on a server but may be resident on either the learner computing device or the educator computing device. The functions of both these devices may be combined into a single device with, of course, the educator computing device functions not being available to the learner. A smaller set of analysis functions and capabilities would also need to be used as the processing and storage capabilities of the learner computing device and the educator computing device may be lower than those of the servers and databases contemplated for the networked and school-implemented versions of the different aspects of the invention.

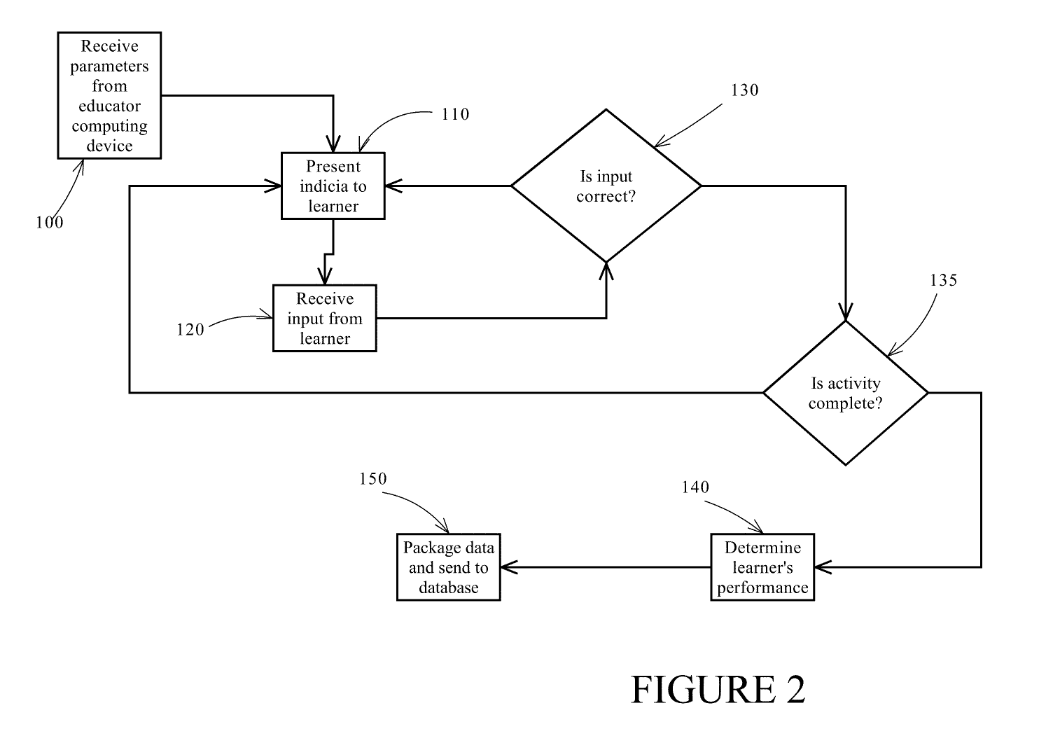

Referring to FIG. 2, a flowchart for the steps in a method according to another aspect of the invention is illustrated. Step 100 begins the method with the learner computing device receiving parameters from an educator computing device. The parameters relate to an activity about to be presented to the learner. Once the parameters have been received, the activity begins and the learner is presented with indicia relating to the activity (step 110). This indicia can take many forms and is dependent on the activity. As an example, for the counting activity described above, the indicia can be a bug with a number of dots (which may be activated by the user) on its wing. Similarly, if the activity is that of matching young animals with their parents, the indicia includes not just the young animals but the parent animals and whatever background art may be necessary or desirable. The indicia may, of course, be configured so that the learner can interact with the indicia. Thus, the learner may click, drag, tap, activate or otherwise interact with at least some of the indicia to provide input for the activity.

Once the indicia has been presented to the learner, the learner computing device then receives input from the learner by way of the learner interacting with the indicia (step 120). This step continues until the learner has completed input for the activity. The learner's input is then determined to be correct or incorrect (step 130). If the learner's input or set of inputs is incorrect, the logic of the method loops back to step 110 as the indicia is, again, presented to the learner. Steps 110-130 iterate until the learner completes the activity by correctly entering a suitable set of inputs that correspond to predetermined correct inputs or until a set number of iterations have been completed. Of course, as noted above, the set number of iterations may be determined by one of the parameters received from the educator computing device. It should be noted that the indicia may be changed at each iteration of steps 110-130.

Once the learner has completed the activity or once the number of allowed iterations has been reached (decision 135), the performance of the learner is then determined (step 140). This step may involve counting the number of iterations until the activity was completed, determining if the activity was successfully completed at all, determining how long it took to complete the activity, and determining if any errors (and how many) were made before the activity was completed. Of course, other performance measures may be used to determine the learner's performance relating to the activity.

With the performance data gathered, this performance data as well as the learner's identity can then be packaged as a data package or as a database entry for transmission such that it can be stored in the database. In one implementation, the data package/database entry is transmitted to the server where the database resides (step 150).

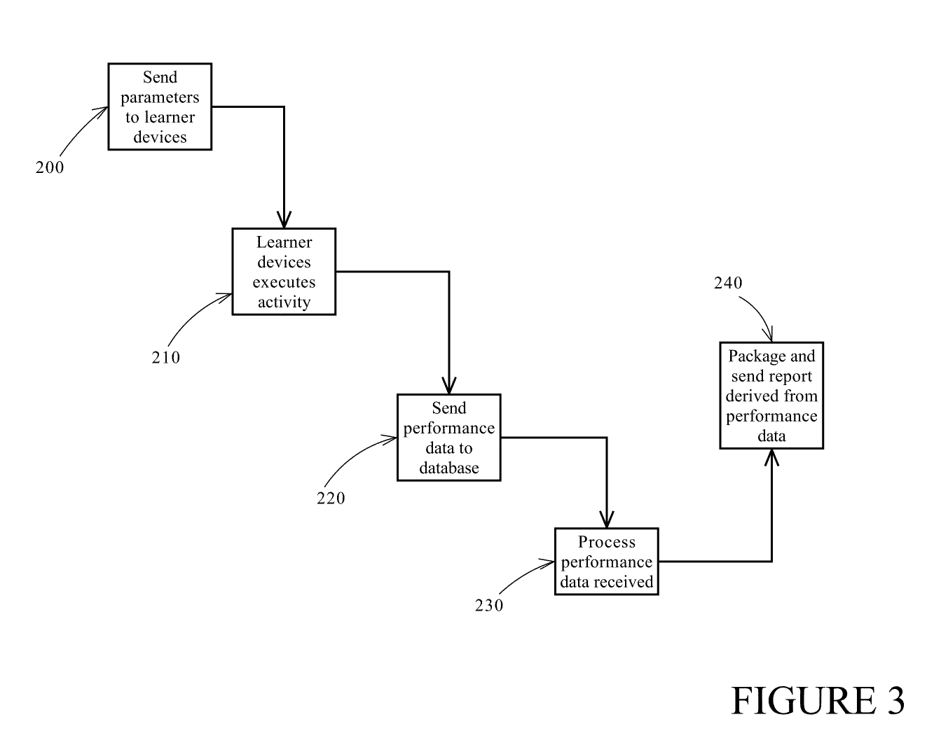

Referring to FIG. 3, a flowchart for another method for another aspect of the invention is illustrated. The method begins at step 200, that of the educator computing device sending parameters regarding an activity to one or more learner computing devices. Step 210 is that of the various learner computing devices executing the activity in conjunction with the learners. Once the activity has been completed on each of the learner computing devices or once a predetermined number of iterations of the activity has been completed, each learner computing device sends performance data (as separate database entries with each device producing one database entry for each instance that the activity has been completed by a learner) for storage in the database (step 220). Of course, the performance data relates to the performance of a learner using the learner computing device. Once the performance data has been received, the server then processes this data (step 230). The processed performance data is then packaged and sent from the server to the educator computing device (step 240).

As can be seen from the above, another aspect of the invention involves determining a learner's progress towards achieving a target milestone. The method for this aspect of the invention starts with providing the learner with digital content with an educational component. This is done by way of the learner computing device. The learner then completes the digital content's activity/application and the learner computing device gathers the learner's performance data. The performance data is then packaged as a database entry and is uploaded to a database. Once in the database, the educator can request reports be constructed based on specific parameters. One report may detail a specific target milestone and may illustrate how many learners in a class have achieved that milestone based on the data in the database. In addition to documenting how many learners met the milestone, the report can provide further details as to which learners did not achieve the target milestone and which lower level milestones were achieved by these learners. This is done by the server mining the database for the highest milestones achieved by each learner in the class and retrieving reasons for those achievements. Of course, milestones may be broken up into subject areas or categories if desired. As well, the report can also include recommended activities and other materials for each of the learners based on their achieved milestones. This aspect of the report can be constructed by cross-referencing each learner's learner profile (including their achieved milestones) with the reference database and its entries regarding each milestone and recommended activities. Each learner's unachieved milestones (i.e. milestones which were highlighted by completed activities but which were not achieved by the learner) can be extracted from each learner's profile and the recommended activities for these milestones can be included in the report for each learner.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for providing educational digital content to learners, the system comprising:
at least one learner computing device, each of said at least one learner computing device being for use by at least one learner;
an educator computing device for use by an educator, said educator computing device communicating with said at least one learner computing device;
a server communicating with said at least one learner computing device and said educator computing device, said server being for storing and processing data received from said at least one learner computing device;
a database receiving and storing data entries originating from each of said at least one learner computing device, each entry detailing an activity used by said learner and said learner's performance in said activity;
wherein
said at least one learner computing device presents said activity to one of said at least one learner;
said at least one learner computing device gathers data regarding said performance of said at least one learner in said activity and sends said data as a database entry such that said database entry is stored in said database;
each database entry stored by said database and originating from said at least one learner computing device details
an activity,
an identity of said learner,
a result of said activity for said learner,
performance data for said learner for said activity, and
reasons for said result;
said server processes said database entries regarding said performance and generates at least one report on said activity, said at least one report being viewable by said educator on said educator computing device.

2. A system according to claim 1 wherein each of at least one learner is provided with a specific profile on said at least one learner computing device and said database, performance data for each learner being stored on said database.

3. A system according to claim 2 wherein said educator computing device monitors each of said at least one learner computing device.

4. A system according to claim 1 wherein processed data sent by said server to said educator computing device indicates an effectiveness of an educator's methods based on said data gathered and said performance.

5. A system according to claim 1 wherein said activity for said learner involves at least one of: counting, spelling, arithmetic, and matching images.

6. A system according to claim 1 wherein said processed data is displayed on said educator computing device using a display indicating a performance for each one of said at least one learner for said activity.

7. A system according to claim 1 wherein said database includes a reference database containing entries for different milestones achievable by said learners upon completion of various activities.

8. A system according to claim 1 wherein said parameters include at least one of:
duration of said activity;
number of iterations for said activity in the event said learner is unable to complete said activity; and
changes to said activity for each iteration.

9. A method for providing educational digital content to a learner, the method comprising:
a) receiving parameters for an activity from an educator computing device;
b) providing said activity to a learner computing device by providing activity-related indicia to said learner;
c) receiving input from said learner, said input being related to said activity;
d) determining said learner's performance for said activity;
e) generating performance data based on said performance;
f) transmitting performance data as a database entry for storage on a database;
wherein
each activity relates to at least one milestone;
data stored in said database includes data on said learner and which milestones have been achieved by said learner;
each database entry stored by said database and originating from said at least one learner computing device details
an activity,
an identity of said learner,
a result of said activity for said learner,
performance data for said learner for said activity, and
reasons for said result.

10. A method according to claim 9 wherein said performance in step f) is based on at least one of:
determining if said activity was completed;
a number of iterations required before said learner completed said activity;
determining if said activity was not completed even after said predetermined number of iterations was exhausted; and
determining if said activity was partially completed.

11. A method according to claim 9 wherein said parameters comprises at least one of:
duration of said activity;
number of iterations for said activity in the event said learner is unable to complete said activity; and
changes to said activity for each iteration.

12. A method according to claim 9 wherein said activity involves counting, spelling, arithmetic, and matching images.

13. A method according to claim 9 including a step of receiving a login input from said learner prior to step a).

14. A method according to claim 9 wherein said learner computing device is shared among at least two learners, each learner logging in to said learner computing device to access his profile on said learner computing device, each learner being provided with profiles on said learner computing device and said database.

15. A method for determining a learner's progress regarding a target milestone, the method comprising:
a) providing educational digital content to said learner by way of an activity presented to said learner through a learner computing device;
b) determining said learner's performance in said activity;
c) uploading said learner's performance data for said activity as part of a database entry to a database;
d) determining if said learner has met specific milestones based on said learner's performance data stored in said database;
e) determining if said learner has met enough milestones to achieve a target milestone based on said data stored in said database;
f) in the event said learner has not met enough milestones for said target milestone, determining which milestones have been achieved;
g) generating a report based on results from steps d), e), and f) and sending said report to an educator computing device;
wherein
each database entry stored by said database and derived from said performance data originating from said at least one learner computing device details
said activity,
an identity of said learner,
a result of said activity for said learner,
performance data for said learner for said activity, and
reasons for said result.

16. A method according to claim 15 wherein steps d), e), and f) are executed by gathering data relating to specific learners in said database.

17. A method according to claim 16 wherein said step of gathering data relating to specific learners includes determining which highest milestones have been achieved by said specific learners.

18. Computer readable media having encoded thereon computer readable and computer executable instructions which, when executed, implements a method for providing educational digital content to a learner, the method comprising:
a) receiving parameters for an activity from an educator computing device;
b) providing said activity to a learner computing device by providing activity-related indicia to said learner;
c) receiving input from said learner, said input being related to said activity;
d) determining said learner's performance for said activity;
e) generating performance data based on said performance;
f) transmitting performance data as a database entry for storage on a database;
wherein
each activity relates to at least one milestone;
data stored in said database includes data on said learner and which milestones have been achieved by said learner;
each database entry stored by said database and originating from said at least one learner computing device details
an activity,
an identity of said learner,
a result of said activity for said learner,
performance data for said learner for said activity, and
reasons for said result.
